(19) United States
(12) Patent Application Publication
(10) Pub. No.: US 2006/0253639 A1
(43) Pub. Date: Nov. 9, 2006

(54) Control system for controlling a plurality of target computers through portable computer

(75) Inventors: Chieh-Kwei Lee, Taipei Hsien (TW); Chao-Hsuan Hsueh, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Aten International Co., Ltd.

(21) Appl. No.: 11/122,911

(22) Filed: May 5, 2005

(51) Int. Cl. G06F 13/20; G06F 13/00

(52) U.S. Cl. 710/313; 710/316

(57) ABSTRACT

A control system for controlling target computers through a portable computer is disclosed. The control system includes a first USB device controller, a second USB device controller, and a third USB device controller. The first USB device controller transmits a first input signal and receives video data. The second USB device controller transmits a second input signal and receives video data. The third USB device controller transmits the video signal coming from the first or the second target computers to the portable computer and receives the first or the second input signals from the portable computer. The portable computer controls the first target computer by the first input signal and controls the second target computer by the second input signal.

### BACKGROUND

1. Field of Invention

The present invention relates to a control system for allowing a portable computer to control a plurality of target computers. More particularly, the present invention relates to a control system for allowing a portable computer to control a plurality of target computers through a USB transmission protocol.

2. Description of Related Art

A KVM (Keyboard, Video, and Mouse) switch allows a set of user interface devices, such as a keyboard, a mouse or a display, to control a plurality of computers. The KVM switch is connected to the user interface devices and the plurality of target computers. Video signal of each target computer should be transmitted, via the KVM, to the display of the user interface devices. Commands from the user interface devices should be sent, through the KVM switch, to a specified target computer. Thus, user interface devices can control each target computer.

Conventionally, the transmission of video signal between the target computer and the user interface devices is achieved using a VGA connection. The transmission of commands (usually generated by a mouse or a keyboard) is achieved by PS/2 connection. Thus, three connections should be made for the KVM to transmit complete information to single target computer. For a great number of target computers, the three-connection configuration is complex and inconvenient. Therefore, there is a need to integrate the three connections into a single and convenient connection.

On the other hand, a portable computer, which has built-in keyboard, touch pad and LCD display, is suitable to act as a user interface devices or a console in a KVM switch system. However, at present, there is no solution able to achieve this purpose.

### SUMMARY

It is therefore an objective of the present invention to provide a control system for allowing at least one portable computer to conveniently access and control target computers.

It is therefore another objective of the present invention to provide a control system for allowing at least one portable computer to utilize its screen and keyboard to serve as a convenient console to control a plurality of target computers.

It is therefore still another objective of the present invention to provide a control system for allowing at least one portable computer to control a plurality of target computers through a USB transmission protocol.

It is still another objective of the present invention to provide a control system for allowing at least one portable computer to control a plurality of target computers, where fast and commonly used USB transmission protocol is adopted in the control system.

In accordance with the foregoing and other objectives of the present invention, a control system for allowing at least one portable computer to control at least a first target computer and a second target computer through a USB transmission protocol is described. According to one embodiment of the invention, the control system includes a first USB device controller, a second USB device controller, and a third USB device controller.

The first USB device controller is electrically connected to the first target computer. The first USB device controller uses an interrupt transfer to transmit a first input signal and uses a bulk-in-transfer to receive video signal from the first target computer.

The second USB device controller is electrically connected to the second target computer. The second USB device controller uses an interrupt transfer to transmit a second input signal and uses a bulk-in-transfer to receive video signal from the second target computer.

The third USB device controller is electrically connected to the portable computer. The third USB device controller uses a bulk-out-transfer to transmit the video signal coming from one of the first and the second target computers to the portable computer and uses a bulk-in transfer to receive one of the first and the second input signals from the portable computer. The portable computer controls the first target computer by the first input signal and controls the second target computer by the second input signal.

In accordance with the foregoing and other objectives of the present invention, a control system for allowing at least one portable computer to control at least a first target computer and a second target computer through a USB transmission protocol is described. According to one embodiment of the invention, the control system includes a first USB interface, a second USB interface, and a third USB interface.

The first USB interface is electrically connected to the first target computer. The first USB interface receives first video signal of the first target computer and simulates an input device to transmit a first command to the first target computer.

The second USB interface is electrically connected to the second target computer. The second USB interface receives second video signal of the second target computer and simulates an input device to transmit a second command to the second target computer.

The third USB interface is electrically connected to the portable computer. The third USB interface transmits one of the first and the second video signal to the portable computer and receives one of the first and the second commands from the portable computer.

Programs supporting the USB transmission protocol are respectively executed in the first target computer, the second target computer, and the portable computer. The portable computer controls the first target computer by the first command, and controls the second target computer by the second command.

The invention has at least the following advantages. Each embodiment can present one or more of the advantages. The control system allows at least one portable computer to conveniently access and control target computers. The control system allows at least one portable computer to utilize its screen and keyboard to serve as a convenient console to control a plurality of target computers. The control system allows at least one portable computer to control a plurality of target computers through a USB transmission protocol. All video signal and commands are transmitted by USB communication protocol, which is a fast and commonly used standard protocol.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows an application of a USB KVM according to one embodiment of the invention;

FIG. 2 shows a block diagram of an embodiment according to the invention;

FIG. 3 shows a block diagram of another embodiment according to the invention; and

FIG. 4 shows a more detailed block diagram of the control system 306 of FIG. 3.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

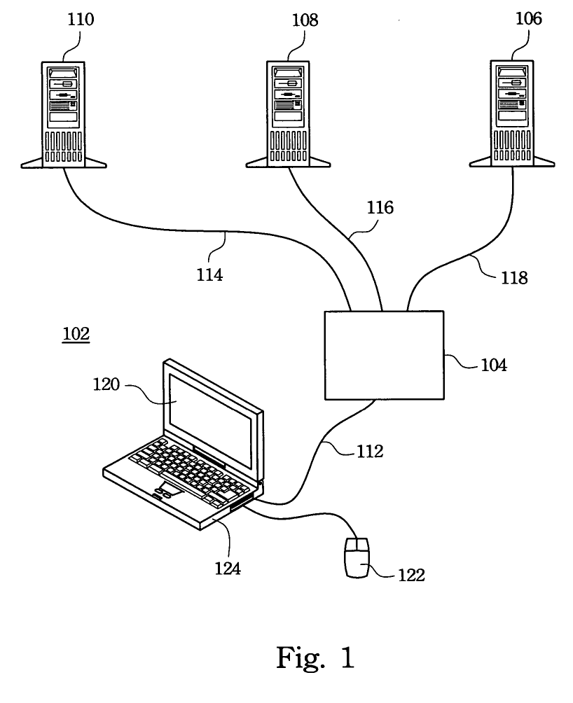

FIG. 1 shows an application of a USB KVM switch according to one embodiment of the invention. A portable computer 102 is connected to target computers 110, 108, and 106 through a control system 104. In this embodiment, a term USB KVM switch is used to refer to the control system 104. A USB (universal serial bus) transmission protocol is used in the connection 112 between the portable computer 102 and the USB KVM switch (the control system 104). The connections 114, 116, and 118 between the USB KVM switch and the target computers 110, 108, and 106 also adopt USB transmission protocol.

Video signal (such as a screen image for users to communicate with the target computer 110) can be transmitted from the target computer 110, via the control system 104, to the portable computer 102. Then, the video signal from the target computer 110 can be shown on the screen 120 of the portable computer 102. After viewing the video data, a user can use a mouse 122 or a keyboard 124 to send a command to the target computer 110 through the control system 104 by a USB communication protocol. Thus, the portable computer 102 can control the target computer 110. Similarly, the user can switch video signal from the target computer 108 or 106 to the portable computer 102 and then control the target computer 108 or 106 by the mouse 122 or the keyboard 124 using a USB communication protocol. Since a USB interface is widely supported in a common computer, using a USB communication protocol to control other computers will provide great convenience. A common desktop computer can be used as an alternative to replace the portable computer 102.

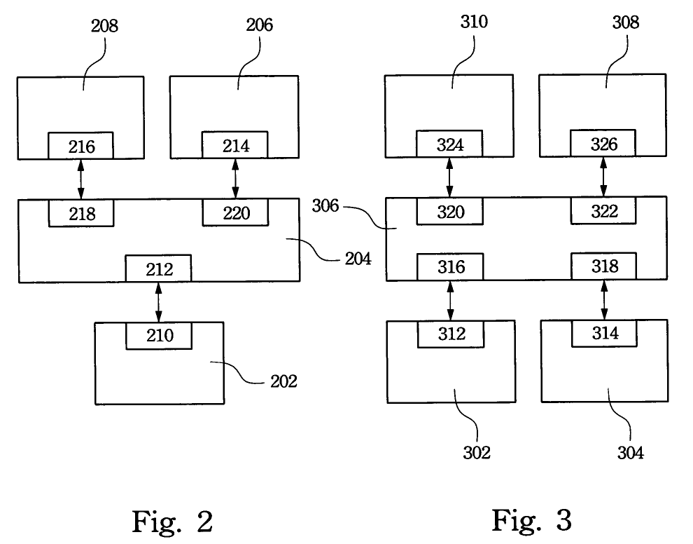

FIG. 2 shows a block diagram of an embodiment according to the invention. A control system 204 is connected to a portable computer 202 through USB ports 212 and 210. The control system 204 also connects to a target computer 208 through USB ports 218 and 216, and connects to a target computer 206 through USB ports 220 and 214. Since only one portable computer 202 is presented, control system 204 is for single user. The target computer 208 uses a first program to transmit video signal to the control system 204 and in turn the portable computer 202. The target computer 206 uses a second program to transmit video signal to the control system 204 and in turn the portable computer 202. The portable computer 202 uses a third program to transmit a first command and a second command to the control system 204 and in turn the target computer 206 or 208. The first command and the second command are used to control the target computer 208 and the target computer 206, respectively.

FIG. 3 shows a block diagram of another embodiment according to the invention. A control system 306 is connected to a portable computer 302 through USB ports 312 and 316, and connected to another portable computer 304 through USB ports 314 and 318. The control system 306 also connects to a target computer 310 through USB ports 320 and 324, and connects to a target computer 308 through USB ports 322 and 326. Since two portable computers 302 and 304 are presented, control system 306 is for multi user. That is, obviously, through the embodiment of the present, a matrix KVM switch using a portable computer as a console device is also achieved. USB programs are respectively executed in the portable computer 302, the portable computer 304, the target computer 310, and the target computer 308 to successfully transmit desired video signal and commands through a USB communication protocol.

For those who skilled in the art, a 4-port, 8-port, 16-port, or 4-user, 8-user control system can be contemplated according to an architecture similar to the above embodiment. The portable computers (or users) can control each target computer according to their corresponding priority.

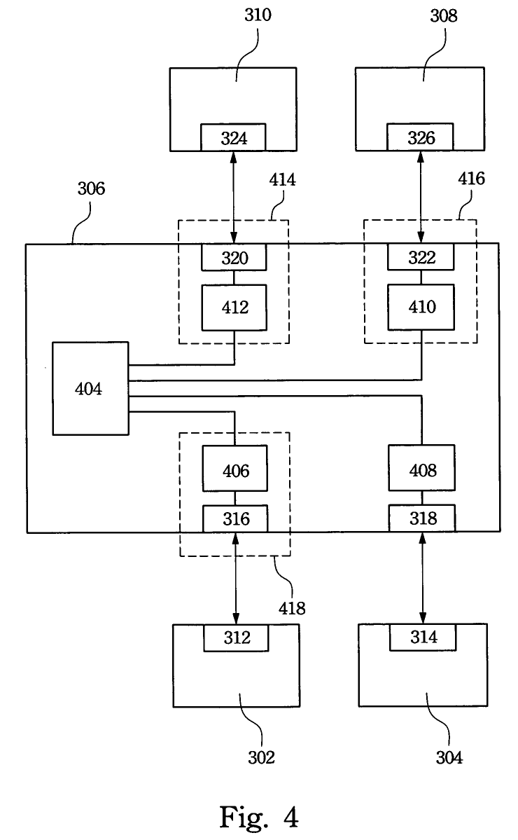

FIG. 4 shows a more detailed block diagram of the control system 306 of FIG. 3. With reference to FIG. 3 and FIG. 4, the control system 306 allows at least one portable computer (such as 302 or 304) to control at least a first target computer 310 and a second target computer 308 through a USB transmission protocol. The control system 306 includes a first USB device controller 412, a second USB device controller 410, and a third USB device controller 406.

A first USB interface 414 is electrically connected to the first target computer 310. The first USB interface 414 includes the USB port 320 and the first USB device controller 412. Thus, the first USB device controller 412 is electrically connected to the first target computer 310 via the USB port 320. The first USB device controller 412 uses an interrupt transfer to transmit a first input signal, such as a keyboard or mouse control signal, and uses a bulk-in-transfer to receive video signal from the first target computer 310.

A second USB interface 416 is electrically connected to the second target computer 308. The second USB interface 416 includes the USB port 322 and the second USB device controller 410. Thus, the second USB device controller 410 is electrically connected to the second target computer 308 via the USB port 322. The second USB device controller 410 uses an interrupt transfer to transmit a second input signal, such as a keyboard or mouse control signal, and uses a bulk-in-transfer to receive video signal from the second target computer 308.

A third USB interface 418 is electrically connected to the portable computer 302. The third USB interface 418 includes the USB port 316 and the third USB device controller 406. Thus, the third USB device controller 406 is electrically connected to the portable computer 302 via the USB port 316. The third USB device controller 406 uses a bulk-out-transfer to transmit the video signal from the first target computer 310 or the second target computer 308 to the portable computer 302 and uses a bulk-in transfer to receive the first input signal or the second input signal from the portable computer 302.

The portable computer therefore controls the first target computer 310 by the first input signal and controls the second target computer 308 by the second input signal.

Four types of transfer (control transfer, interrupt transfer, bulk transfer, and isochronous transfer) are provided in a USB transmission protocol. A bulk transfer is suitable for the transmission of video data. An interrupt transfer is suitable for the transmission of a command generated by a mouse or a keyboard.

The video signal can be successfully transmitted, using a bulk-in transfer and a bulk-out transfer, from the first target computer 310, via the control system 306, to the portable computer 302. The first input signal, which is used to control the first target computer 310, can be sent, using an interrupt transfer, from the portable computer 302, via the control system 306, to the first target computer 310. Therefore, the portable computer 302 can control the first target computer 310 by the first input signal and get a responsive display image from the video signal from the first target computer 310.

Similarly, the control system 306 can switch video signal from the second target computer 308 to the portable computer 312 and switch the second input signal from the portable computer 302 to the second target computer 308. The second target computer 308 is also controlled by the portable computer 302 via the second input signal.

In one embodiment, the control system 306 can further include a control unit 404 for routing the first USB device controller 412, the second USB device controller 410, and the third USB device controller 406. The control unit 404 is, for example, a processor.

In the present invention, the first USB device controller 412 can simulate input devices (such as keyboard or mouse) to the first target computer 310. The first USB device controller 412 simulates at least 3 non-zero endpoints. One non-zero endpoint performs as a keyboard and the first input signal can be sent by the simulated non-zero endpoint. Another non-zero endpoint performs as a mouse and the first input signal also can be sent by the simulated non-zero endpoint. Still another non-zero endpoint performs as a bulk-in-transfer device for transferring down-stream video data. Endpoint zero is for control-transfer and is used to setup the first USB device controller 412 as well as its relative settings.

The third USB device controller 406 simulates at least 2 non-zero endpoints. One non-zero endpoint is a bulk-out-transfer device that can send video signal to the portable computer 302. This non-zero endpoint can also send status of the first input signal to the portable computer 302. The other non-zero endpoint is a bulk-in-transfer device that can get commands (or input signals) from the portable computer 302. The commands (or signals) can include simulated keyboard or mouse data and settings of the third USB device controller 406.

In this embodiment, programs supporting the USB transmission protocol are executed in the first target computer 310 and the portable computer 302, respectively, in order to successfully transmit the video signal and the commands (input signals).

The second USB device controller 410 can have functions similar to the first USB device controller 412. That is, the second USB device controller 410 can simulate input devices (such as keyboard or mouse) to the second target computer 308. Therefore, with the second USB device controller 410, the portable computer 302 can control the second target computer 308 via the control system 306 using the same method.

The control system 306 can further include a forth USB device controller 408. The forth USB device controller 408 is electrically connected to another portable computer 304. The forth USB device controller 408 uses a bulk-out-transfer to transmit video signal from the first target computer 310 or the second target computer 308 to the portable computer 304. The forth USB device controller 408 uses a bulk-in transfer to receive the first input signal or the second input signal. Thus the portable computer 302 and the portable computer 304 control the first target computer 310 and the second target computer 308 according to their corresponding priorities.

The invention has at least the following advantages. Each embodiment can present one or more of the advantages. The control system allows at least one portable computer to conveniently access and control target computers. The control system allows at least one portable computer to utilize its screen and keyboard to serve as a convenient console to control a plurality of target computers. The control system allows at least one portable computer to control a plurality of target computers through a USB transmission protocol. All video signal and commands are transmitted by USB communication protocol, which is a fast and commonly used standard protocol.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control system for allowing a portable computer to control at least a first target computer and a second target computer, the control system comprising:
a first USB device controller electrically connected to the first target computer, the first USB device controller transmitting a first input signal and receiving video signal from the first target computer;
a second USB device controller electrically connected to the second target computer, the second USB device controller transmitting a second input signal and receiving video signal from the second target computer; and
a third USB device controller electrically connected to the portable computer, the third USB device controller transmitting the video signal from one of the first and the second target computers to the portable computer and receiving one of the first and the second input signals from the portable computer;
wherein the portable computer controls the first target computer by the first input signal and controls the second target computer by the second input signal.

2. The control system of claim 1, further comprising a control unit for routing the first, the second, and the third USB device controller.

3. The control system of claim 1, wherein the first USB device controller simulates one endpoint as a keyboard during boot of the first target computer.

4. The control system of claim 1, wherein the first USB device controller simulates one endpoint as a mouse during boot of the first target computer.

5. The control system of claim 1, wherein the second USB device controller simulates one endpoint as a keyboard during boot of the second target computer.

6. The control system of claim 1, wherein the second USB device controller simulates one endpoint as a mouse during boot of the second target computer.

7. The control system of claim 1, wherein the third USB device controller uses a bulk-out-transfer to send statuses of the first and the second input signals to the portable computer.

8. The control system of claim 1, wherein a program supporting the USB transmission protocol is executed in the first target computer.

9. The control system of claim 1, wherein a program supporting the USB transmission protocol is executed in the second target computer.

10. The control system of claim 1, wherein a program supporting the USB transmission protocol is executed in the portable computer.

11. The control system of claim 1, further comprising a forth USB device controller electrically connected to another portable computer, wherein the forth USB device controller transmitting a video signal from one of the first and the second target computers to the another portable computer and receiving one of the first and the second input signals, whereby the portable computer and the another portable computer control one of the first and the second target computers.

12. A control system for allowing at least one portable computer to control at least a first target computer and a second target computer, the control system comprising:
hardware components, comprising:
a first USB interface electrically connected to the first target computer, wherein the first USB interface receives first video signal of the first target computer and simulates an input device to transmit a first command to the first target computer;
a second USB interface electrically connected to the second target computer, wherein the second USB interface receives second video signal of the second target computer and simulates an input device to transmit a second command to the second target computer; and
a third USB interface electrically connected to the portable computer, wherein the third USB interface transmits one of the first and the second video signal to the portable computer and receives one of the first and the second commands from the portable computer; and
a software module, comprising:
a first program for the first target computer to transmit the first video signal to the first USB interface;
a second program for the second target computer to transmit the second video signal to the second USB interface;
a third program for the portable computer to transmit the first command and the second command to the third USB interface,
wherein the portable computer controls the first target computer by the first command, and controls the second target computer by the second command.

13. The control system of claim 12, wherein the first USB interface further comprises a first USB device controller, and the first USB device controller uses an interrupt transfer to transmit the first command and uses a bulk-in-transfer to receive the first video data.

14. The control system of claim 12, wherein the second USB interface further comprises a second USB device controller, and the second USB device controller uses an interrupt transfer to transmit the second command and uses a bulk-in-transfer to receive the second video data.

15. The control system of claim 12, wherein the third USB interface further comprises a third USB device controller, and the third USB device controller uses a bulk-out-transfer to transmit one of the first and the second video signal to the portable computer and uses a bulk-in transfer to receive one of the first and the second commands.

16. The control system of claim 12, wherein the hardware components further comprise a control unit for routing the first, the second, and the third USB interfaces.

17. The control system of claim 12, wherein the hardware components further comprise a forth USB interface electrically connected to another portable computer, the forth USB interface comprises a forth USB device controller, transmitting video signal from one of the first and the second target computers to the another portable computer and receiving one of the first and the second commands, whereby the portable computer and the another portable computer control the first and the second target computers by the first and the second commands.
